(19) United States
(12) Patent Application Publication
(10) Pub. No.: US 2013/0311300 A1
(43) Pub. Date: Nov. 21, 2013

(54) METHOD OF ADVERTISING TECHNOLOGY

(71) Applicant: Andrew Scarborough, New South Wales (AU)

(72) Inventor: Andrew Scarborough, New South Wales (AU)

(21) Appl. No.: 13/475,026

(22) Filed: May 18, 2012

(51) Int. Cl. G06Q 30/02

(52) U.S. Cl. 705/14.69

(57) ABSTRACT

There is disclosed a method of presenting advertisements on devices or apparatus (18) in which software applications (“apps”) can be installed, pre-installed, or run. The invention involves the identification of stages of use of the apps, and of advert types for presenting on the devices, and of subsets of those advert types suitable for those stages. The method includes the steps (12, 14, 16) of providing software codes for implementation in apps, and adapted to configure the apps to cause advert types from the subsets to be presented on the devices during relevant stages. The method also includes becoming eligible for remuneration when predetermined interactions occur between device users and the advertisements.

### 37 C.F.R. §1.71(E) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### CROSS REFERENCE TO RELATED APPLICATIONS, IF ANY

Not applicable.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

This invention relates to advertising on devices adapted to run software applications (apps), in particular smart phones and tablet computers, and more specifically, to a method of advertising.

2. Background Information

Smart phone devices have become very popular in recent years. With this popularity, the industry for developing software applications (known as “apps”) for smart phone devices has become large. This industry has also extended to tablet computers, on which apps can also be run. Indeed, there are many developers that develop apps to suit an extremely wide range of differing interests amongst smart phone device and tablet users. These include, for example, apps for games or other forms of entertainment, apps for business purposes, apps for education and information sharing, and so on.

Such apps have been identified as an effective medium for advertising. Indeed, it is very common for the goods or services of one provider to be advertised on the apps developed by another party. Such adverts typically appear in visual form on the screens of smart phone devices, while users are interacting with the devices.

It will be appreciated that, in order for an advert of a particular provider to be presented during the use or running of an app on a smart phone device, the app must be suitably configured to cause that advert to appear. Usually, an intermediate party is involved in taking the steps necessary for the provider's advert to be included in the developer's app.

There are numerous competing businesses that act as such intermediaries, often referred to as advertising (or ad) networks. Typically, such businesses will have information about providers wishing to advertise on apps developed by developers, and also information relating to such developers. As a result, such advertising networks are often well-placed to introduce providers that wish to advertise, to app developers wishing to incorporate the adverts of providers within their apps.

Part of the service typically provided by advertising networks includes the developing and providing of software which is suitable to be installed in the apps of developers, in order to incorporate the adverts of providers. Such software may be of a largely standardized nature, and may require relatively little input by the providers, or by the ad network itself, in order to incorporate the provider's adverts, and relatively little adaptation by the app developers (of that software or their apps).

Typically, the apps together with the incorporated software are configured to be presented on the smart phone devices or tablet computers, and for users to interact with the adverts, for example by actuating hyperlinks incorporated in the adverts when they are presented, or by entering information into on-screen forms presented by the adverts, and so on. Typically, the relationship between the providers, ad networks, and app developers is such that, when some predetermined form of interaction occurs between a user of a smart phone device or tablet computer and an advert (for example when the user actuates a hyperlink), a record will be retained of the event, and will trigger a remuneration payment for the ad network and to the developer, which will be paid by the advertising provider.

Indeed, this is typically the primary source of revenue for many developers. For this reason, many apps are made available for download by smart phone device or tablet computer users for free, or for a nominal fee.

There are various different forms of adverts that may be used in such apps. However, the approach to making the adverts as effective as possible in relation to their ability to draw smart phone or tablet computer users to engage with the adverts, and to purchase the goods or services to which the adverts relate, has been somewhat hit and miss. As a result, there is potential for improvement in the effectiveness of adverts, based on the manner in which they are used.

It is an object of the present invention to overcome or ameliorate disadvantages of the prior art, or to propose a useful alternative thereto.

### BRIEF SUMMARY OF THE INVENTION

According to the invention there is provided a method of presenting advertisements on app devices,
wherein a plurality of stages of use of apps on app devices have been identified,
wherein a plurality of advert types for presenting on app devices have been identified, and
wherein for each said usage stage, a subset of said plurality of advert types has been identified, which is suitable for the particular stage, wherein each subset consists of at least one of the advert types, the method including:
1.1 providing software codes for implementation in an app, the software codes being adapted to configure the app, when run on an app device, to cause at least one advert type from each of a plurality of subsets to be presented on the app device during the stage identified for the particular subset; and
1.2 becoming eligible to receive remuneration when a predetermined interaction occurs between a user of the app device and a said advertisement presented on the app device.

In a preferred embodiment, the method includes the steps, prior to the step 1.1, of:
2.1 identifying said plurality of stages of use of apps on app devices;
2.2 identifying said plurality of advert types for presenting on app devices; and
2.3 identifying said subsets of said plurality of advert types.

In a preferred embodiment, said plurality of usage stages includes an entry stage of app usage in which a user of the app device has installed an app on the device, but has not yet begun to use the app.

In a preferred embodiment, said plurality of usage stages includes an engagement stage of app usage in which a user of the app device has installed an app on the device and is in the course of using the app.

In a preferred embodiment, said plurality of usage stages includes an exit stage of app usage in which a user of the app device has finished using the app.

In a preferred embodiment, said plurality of advert types includes an advanced overlay ad type, an interstitial ad type, a banner ad type, a capture form ad type, an app wall ad type, a video ad type, an advanced overlay ad type, a notification ad type, and an app icon ad type.

In a preferred embodiment, said plurality of usage stages includes an entry stage of app usage in which a user of the app device has downloaded an app onto the device, but has not yet begun to use the app, an engagement stage of app usage in which a user of the app device has downloaded an app onto the device and is in the course of using the app, an exit stage of app usage in which a user of the app device has finished using the app, and wherein for the entry stage, the subset includes an advanced overlay ad type, an interstitial ad type, a banner ad type, and a capture form ad type.

In a preferred embodiment, said plurality of usage stages includes an entry stage of app usage in which a user of the app device has downloaded an app onto the device, but has not yet begun to use the app, an engagement stage of app usage in which a user of the app device has downloaded an app onto the device and is in the course of using the app, an exit stage of app usage in which a user of the app device has finished using the app, and wherein for the engagement stage, the subset includes an app wall ad type, a video ad type, an advanced overlay ad type, an interstitial ad type, and a banner ad type.

In a preferred embodiment, said plurality of usage stages includes an entry stage of app usage in which a user of the app device has downloaded an app onto the device, but has not yet begun to use the app, an engagement stage of app usage in which a user of the app device has downloaded an app onto the device and is in the course of using the app, an exit stage of app usage in which a user of the app device has finished using the app, and wherein for the exit stage, the subset includes a notification ad type and an app icon ad type.

In one preferred embodiment, each subset is different to each other subset.

Any reference to the prior art in this specification is not intended, and is not to be taken, as any admission that the prior art forms part of the common general knowledge in Australia or anywhere else.

In this specification, the term “app device” means a device or apparatus in which an app can be installed, pre-installed, or run, including a smart phone device, tablet computer, touch pad device, motion sensing device, voice sensing device, implantable device, audio, stereo or music device, visual device, motor or transport vehicle, table or surface, wearable item, clothing, or glasses. A reference to an “app” is a reference to a software application for such devices or apparatus.

Reference to an advert being presented or the presenting of an advert includes presenting the advert visually or audibly.

The terms “ad” and “advert” are abbreviations for the word “advertisement”.

When reference is made to activating a hyperlink on a device, this is a reference to a user of the device touching an icon or area on a touch screen of the device in which the hyperlink is located, typically with the user's finger or another implement such as a touch pen, or where the user “clicks” on the hyperlink by positioning a cursor on the screen on the hyperlink and pressing a button on the device to actuate the hyperlink.

### BRIEF DESCRIPTION OF THE SEVERAL VIEWS OF THE DRAWING

Preferred embodiments of the invention will now be described, by way of example only, with reference to the accompanying drawings in which:

FIG. 1 is a flow diagram representing three stages of app usage according to an embodiment of the invention; and

FIGS. 2 to 9 are schematic representations of a smart phone device, illustrating different ad types according to an embodiment of the invention.

### DETAILED DESCRIPTION

According to a preferred embodiment of the invention, there is provided a method of presenting adverts on smart phone devices or tablet computers (both these types of device being referred to herein as “app devices”) which are configured to run apps. Such apps may be “native apps”, i.e. apps installed on the devices, or “web apps”, i.e. apps located on servers remote from the device but accessed and run on the devices. Thus, where reference is made below to running an app on a smart phone, this includes running the app when it is located on such a remote server.

The embodiments below are described in terms of a smart phone, but it is to be understood that they apply equally to tablet computers.

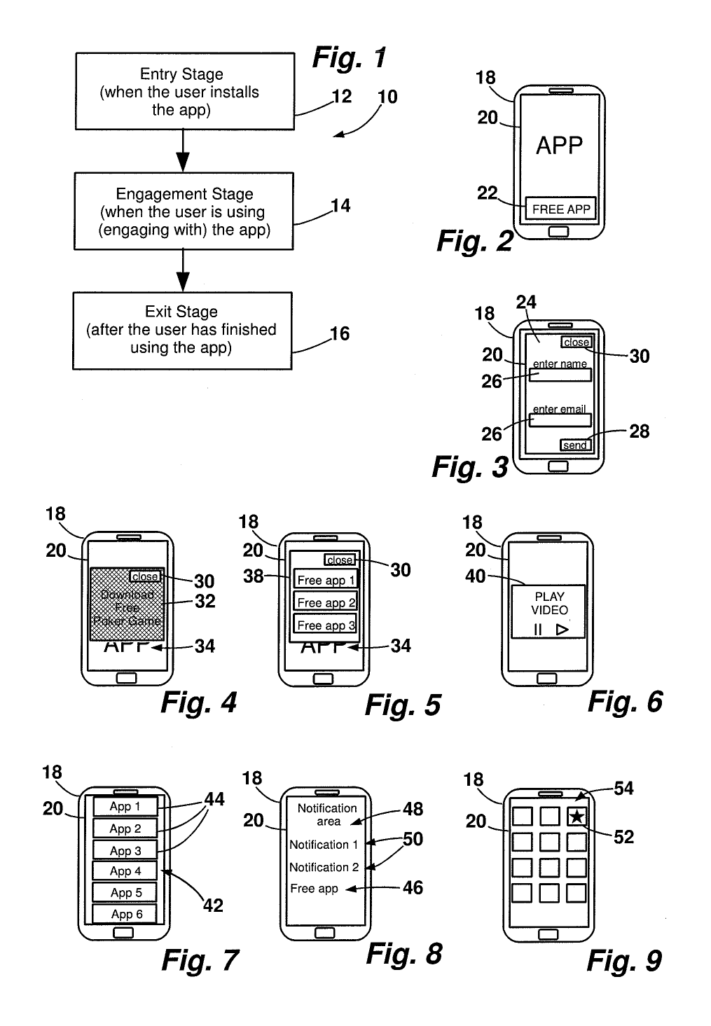

Stages of the “lifecycle” of the usage of an app on a smart phone device involve the user first taking the steps necessary to install the app on the smart phone device. This is illustrated by the flow diagram 10 in FIG. 1, in which this first stage, which is referred to as an Entry Stage, is indicated at 12.

As smart phone devices have Internet capability, this step typically involves the user of the device opening a suitable app on the device, the app being configured to enable the user to access and download other apps from other locations on the Internet. Such an app opened by the user is sometimes referred to as a “discovery app”, while such other locations are often referred to as “app stores” or “app market places”.

An alternative method of downloading an app involves the user navigating on the Internet to a particular website on which the desired type of app is available for download, selecting the app of choice, and downloading the app onto the user's smart phone device.

Another method of downloading an app is for the user to download the app from the Internet onto a computer device (not shown) which is separate from the smart phone device, such as a desktop computer, laptop computer, or the like, and then to download the app from such computer device onto the smart phone device.

Once the app has been downloaded to the smart phone device, the user would typically begin to use the app for the purpose for which it is intended. For example, if the app is for playing a particular game, the user would typically begin to play the game. This stage of the usage of the app is referred to as an Engagement Stage and is illustrated at 14 in FIG. 1.

Depending on the nature of the app, interest in the use of the app may last for a relatively short period, or a longer period. However, it is common, for many different types of app, for the user, after a while of using the app, to lose interest, or no longer to have need to use the app, and therefore to stop using it, either permanently, or for a period of time. This stage is referred to as an Exit Stage and is indicated at 16 in FIG. 1.

As described in further detail below, the above stages 12, 14, 16 of app usage can provide suitable times in which to present different types of advert. In this regard, there are currently a number of different types of advert which are incorporated into apps, for presenting on smart phone devices. These include the adverts described below with reference to a smart phone device 18, having a screen 20, as illustrated in each of these figures.

A banner ad, as illustrated in FIG. 2, is one of the more common types of adverts. It is in the form of a banner 22 that appears on the screen 20 of the smart phone device 18. Such banners 22 can be presented in a variety of different shapes and sizes and can therefore be configured to suit different shapes and sizes of available space as might be provided on the smart phone device screens 20 by different apps. Typical banner ads, when they appear on the screen of the smart phone device, do not block access by the user of the device 18 to the app content of an app being used, or allow access to part of the app content. Typically the full area, or part of the area, of the banner 22 is a hyperlink which can be activated by the user in order to engage with the advert. Often, this will involve an Internet web page relating to the goods or services advertised by the advert, or an app store interface, opening on the smart phone device screen 20, allowing the user to enter into a transaction in relation to those goods or services, or to download relevant software.

A capture form ad, as illustrated in FIG. 3, typically includes an on-screen form 24 with one or more windows 26 in which the user can enter data. For example, such an ad may allow the user, by way of the on-screen form 24, to complete a survey or questionnaire and/or to provide other information relating to the user, the use of the app, and so on. Apart from the windows 26 in which such data can be entered, these forms 24 will often include hyperlinks 28, which allow the users to submit the data over the Internet. They might also include buttons 30 on the screen 20 that allow the user to close or dismiss the form 24.

An interstitial ad, as illustrated in FIG. 4, is an advert 32 that typically appears on the screen 20 of the smart phone device 18 superimposed over app content 34 appearing on the screen of a particular app that is being used by the user. Typically the full area, or part of the area, of the interstitial ad 32 is a hyperlink which can be activated by the user in order to engage with the advert, as in the case of the banner ad described above. Such adverts 32 might also include buttons 30 on the screen 20 that allow the user to close or dismiss the advert.

An advanced overlay ad, as illustrated in FIG. 5, typically includes pages 38 or icons that are presented on the smart phone device screen 20. Once they have appeared, these pages 38 or icons restrict access by the user to app content on the smart phone device 18, until the user performs a predetermined action. For example, such predetermined action may involve the user completing a survey (for example, when the advanced overlay advert includes a capture form such as the form 24 described above), downloading or accessing a new app, etc. Typically the full area, or part of the area, of the advanced overlay ad 38 is a hyperlink which can be activated by the user in order to engage with the advert, as in the case of the banner ad described above. Such adverts might also include buttons 30 on the screen 20 that allow the user to close or dismiss the advert.

A video ad, as illustrated in FIG. 6, is an advert in the form of a movie or video clip 40, that is, in the nature of a traditional television advert. In some embodiments, the full area, or part of the area, of the video ad is a hyperlink which can be activated by the user in order to engage with the advert and watch the video. In some embodiments, the video is configured to begin playing without the need for the user to activate a hyperlink.

An app wall 42, as illustrated in FIG. 7, is a form of advert which consists of an array or “wall” (for example a single column) of individual adverts 44 (sometimes referred to as ad units), each usually representing a particular app which is available for download. Each ad unit 44 may, for example, be in the form of a banner ad similar to the banners 22 described above. This array allows the user to view the ad units 44 relating to the advertised apps and to activate the hyperlink of one (or more than one) app of choice, if necessary scrolling along the array if the full list is too large to be displayed at one time on the smart phone device screen 20. Usually, each ad unit 44 can be accessed in the same manner as the banner ad 22 described above.

A push notification ad 46, as illustrated in FIG. 8, is a type of advert which is used with smart phone devices 18 which have notification areas 48 (such as certain iPhone™ and Android™ devices). A notification area is typically a display on a smart phone device which the user can cause to be presented (i.e. to be called up) on the smart phone device screen 20, to show notifications relating to the device, to the use of the device, or for other purposes. Typically, such notification areas 48 are not specific to any particular app but are a feature of the smart phone device 18 itself. Depending on the type of device 18, the notification area 48 may be presented across substantially the entire screen 20 of the device as shown in FIG. 5, or a thin display strip (not shown), for example at the bottom of the device's screen. Typically, the push notification ad 46 will be presented as one of possibly a number of notifications 50 in the notification area 48, and includes a hyperlink which can be activated by the user to engage with the ad as in the case of the banner ad 22 described above.

An app icon ad, as illustrated in FIG. 9, includes an icon 52 (similar to the types of icon that may be present on a smart phone screen when a user purchases the device) which appears on the screen 20 when a user downloads or engages an app which triggers or invokes the placement of the app icon. The icon 52 would typically appear on the main screen or home screen area 54 of the smart phone device's screen 20. The icon 52 is typically in the form of a hyperlink which, when activated by a user, opens an associated web page, or application, which is configured to provide the user access to an advertised product or service, or a number of different goods and services. In one embodiment, the app icon 52, when its hyperlink is activated, will cause an app wall, such as the app wall 42 of FIG. 7 as described above, to appear.

A preferred embodiment of the invention involves identifying, for each of the above-mentioned stages 12, 14, 16 in the “lifecycle” of app usage, one or more of the above types of advert which is suitable to be presented during each respective stage. The identification of suitable advert types for each stage 12, 14, 16 may be based, for example, on factors such as the expected psychological state, or state of attention, of the user when downloading or using the app, or after the user has finished using the app.

In particular, according to a preferred embodiment, advert types which are identified as being suitable for the entry stage 12 of app usage are as follows:
advanced overlay ad,
interstitial ad,
banner ad, and
capture form ad.

Indeed, it is envisaged that, at this stage 12 when a user is installing an app on a smart phone device 18, or has just completed doing so, the user's sense of anticipation and excitement at the prospect of using the app is likely to be relatively high, and possibly even at its peak, so that the user is likely to be particularly receptive to adverts.

When the user is in such a state, it is envisaged that the user is most likely to be amenable to engaging with the above-mentioned advert types which are considered suitable for this stage 12.

Further according to the preferred embodiment, advert types which are considered suitable for the engagement stage 14 of the app usage lifecycle are as follows:
App wall,
video ad,
advanced overlay ad,
interstitial ad, and
banner ad.

At this stage of the usage lifecycle of the app, it is expected that, as the user will be in the process of using the app, and therefore in a state of heightened engagement with the app, there will be a relatively high motivation of the user to engage with adverts, especially if the adverts are of a high-visibility type.

Further according to the preferred embodiment, advert types which are considered suitable for the exit stage 16 of the app usage lifecycle are:
notification ads, and
app icon ads.

This stage 16 of the lifecycle of usage of the app is when the user is no longer actively using or engaging with the app, and when the app is therefore likely to be out of the user's consciousness.

Accordingly, these advert types are typically not presented on the smart phone device screen 20 in a way which will intrude on the display relating to a particular app being used. Rather, these advert types, as described above, are adapted to appear on the notification area 48 of the device 18, or main screen or home screen area 54.

It will be appreciated that the group of advert types which are considered suitable for each of the three identified stages 12, 14, 16 of the app usage lifecycle are selected from the known types of adverts based on the anticipated effectiveness of the advert types. Thus, each such group of advert types (for a respective stage of the app usage lifecycle) may be considered as a subset of the full list of advert types, and is referred to as such below.

There may be one or more individual ad types in each subset (i.e. the groups of advert types determined to be suitable for each stage of the app usage lifecycle), that is the same as a particular advert type in another subset (i.e. in the group of advert types determined to be suitable for another stage of the app usage lifecycle). For instance, the banner ad is in the subset relating to both the Entry Stage and Engagement Stage. However, in one embodiment, each subset as a whole (that is, the group of advert types determined to be suitable for a particular stage) is different to each other subset. In other embodiments, one or more subsets may be the same as one another.

Typically, in practice, there may be a relatively large number of developers of apps that are amenable to advertising the goods or services of different providers. Similarly, there may be a large number of different providers wishing to advertise their goods and services on such apps. There are also typically a number of intermediate parties, often referred to as ad networks, that play a role in facilitating introduction of such providers to such app developers, and assisting the app developers to incorporate the providers' adverts within the developers' apps.

Usually, this process would involve the ad network providing a particular app developer with a portion of software code to be incorporated in the app, which is suitable for causing the advert of the desired type to appear when the app has been installed on a smart phone device 18 and is used by a user of the device. The advert would be that of a particular provider.

The portion of software code is preferably in the form of binary code, but in other embodiments may be in the form of source code, libraries, software development kits (sdk), or other forms.

For adverts suitable for the Exit Stage as mentioned above, namely notification ads 46 and app icon ads 52, the software code incorporated in the app may be configured to enable these types of adverts to be engaged even after the app has been uninstalled from the smart phone device 18. In the case of the notification ads 46, the app may be configured to “register” the smart phone device 18—for instance to register it with the ad network—for future notification ads to be sent (pushed) to it regardless of whether the app has been uninstalled. In the case of the app icon ads 52, the app may be configured to allow the icon to remain on the smart phone device 18 after the app is uninstalled, so that the user can continue to activate the icon.

In many instances, the providers will have suitable input into this process, in order to customize the adverts to their own requirements, for example by entering suitable text, graphic images, and so on. To enable this, the ad network would typically give a provider access to a suitable web interface or other interface, such as an application programming interface (API), or provide relevant software to the provider and suitable software to the app developer.

Depending on the nature of the app and software provided by the ad network to the app developer, a certain amount of adaptation of the provided software may need to be made by the app developer, usually with the support of the ad network, to adapt the app to accommodate the provided software.

It is envisaged that, when an ad network is engaged in initial discussions with an app developer regarding the possibility of incorporating adverts in the app developer's app, the option of having advert types selected to match particular identified stages 12, 14, 16 within the usage lifecycle of an app would be communicated by the ad network to the app developer. This would typically be for the purpose of assisting to maximize revenue for the app developer. Usually, the app developer would incorporate, within its app, software codes provided by the ad network, the codes being adapted to feature adverts, of the relevant types, in different identified stages 12, 14, 16 of the usage lifecycle of the app.

According to preferred embodiments, remuneration will be provided to the app developer and ad network for the respective roles of these parties in presenting the adverts of the provider, and this remuneration would typically be provided by the provider. The trigger event for the remuneration would depend on the configuration of the particular app and adverts, and the deal that has been agreed between the parties.

There are a number of ways of triggering the remuneration for the app developer and ad network. These include the following:
“earning per click” (“epc”) or “cost per click” (“cpc”) which is a remuneration triggered by a user of a smart phone device activating a hyperlink;
“earning per action” (“epa”) or “cost per action” (“cpa”) which is a remuneration triggered by some other action taken by the user (e.g. completing a form in a capture form ad);
“earning per install” (“epi”) or “cost per install” (“cpi”) which is a remuneration triggered by the installation, on the smart phone device, of an app or software to which the advert relates;
“cost per mille” (“cpm”) or cost per one thousand impressions, which is a remuneration triggered by an advert being presented each one thousand times (sometimes also referred to as “earnings for cost per mille” (“epcm”); and
“earnings per view” (“epv”) or “cost per view” (“cpv”) which is a remuneration triggered by each viewing by a user of a presented advert.

The identifying of discrete stages of the usage cycle, and the identification of advert types which may be more suitable for one particular stage than any other, and the allocation of such advert types to the relevant stages, may provide a means to render the advertising process more effective. This, in turn, may assist in increasing the success rate, that is, the average number of times per use of a particular type of app that smart phone device users will engage with specific adverts. This can have the effect of increasing revenue for both the app developers and ad networks, and can potentially also bring about a greater number of sales of the advertised goods and services of the providers.

Although the invention is described above with reference to specific embodiments, it will be understood by those skilled in the art that it is not limited to those embodiments, but may be embodied in other forms.

For example, while the preferred forms of the invention are described in relation to all three of the above-mentioned stages 12, 14, 16 of the app usage lifecycle, in other embodiments, a combination of only two of the stages might be included, or alternatively, different stages might be identified instead.

The invention claimed is:

1. A method of presenting advertisements on app devices,
wherein a plurality of stages of use of apps on app devices have been identified,
wherein a plurality of advert types for presenting on app devices have been identified, and
wherein for each said usage stage, a subset of said plurality of advert types has been identified, which is suitable for the particular stage, wherein each subset consists of at least one of the advert types,
the method including:
1.1 providing software codes for implementation in an app, the software codes being adapted to configure the app, when run on an app device, to cause at least one advert type from each of a plurality of subsets to be presented on the app device during the stage identified for the particular subset; and
1.2 becoming eligible to receive remuneration when a predetermined interaction occurs between a user of the app device and a said advertisement presented on the app device.

2. The method of claim 1 including the steps, prior to the step 1.1, of:
2.1 identifying said plurality of stages of use of apps on app devices;
2.2 identifying said plurality of advert types for presenting on app devices; and
2.3 identifying said subsets of said plurality of advert types.

3. The method of claim 1, wherein said plurality of usage stages includes an entry stage of app usage in which a user of the app device has installed an app on the device, but has not yet begun to use the app.

4. The method of claim 1, wherein said plurality of usage stages includes an engagement stage of app usage in which a user of the app device has installed an app on the device and is in the course of using the app.

5. The method of claim 1, wherein said plurality of usage stages includes an exit stage of app usage in which a user of the app device has finished using the app.

6. The method of claim 1, wherein said plurality of advert types includes an advanced overlay ad type, an interstitial ad type, a banner ad type, a capture form ad type, an app wall ad type, a video ad type, an advanced overlay ad type, a notification ad type, and an app icon ad type.

7. The method of claim 1, wherein said plurality of usage stages includes
an entry stage of app usage in which a user of the app device has downloaded an app onto the device, but has not yet begun to use the app,
an engagement stage of app usage in which a user of the app device has downloaded an app onto the device and is in the course of using the app.
an exit stage of app usage in which a user of the app device has finished using the app, and
wherein for the entry stage, the subset includes an advanced overlay ad type, an interstitial ad type, a banner ad type, and a capture form ad type.

8. The method of claim 1, wherein said plurality of usage stages includes
an entry stage of app usage in which a user of the app device has downloaded an app onto the device, but has not yet begun to use the app,
an engagement stage of app usage in which a user of the app device has downloaded an app onto the device and is in the course of using the app.
an exit stage of app usage in which a user of the app device has finished using the app, and
wherein for the engagement stage, the subset includes an app wall ad type, a video ad type, an advanced overlay ad type, an interstitial ad type, and a banner ad type.

9. The method of claim 1, wherein said plurality of usage stages includes
an entry stage of app usage in which a user of the app device has downloaded an app onto the device, but has not yet begun to use the app,
an engagement stage of app usage in which a user of the app device has downloaded an app onto the device and is in the course of using the app.
an exit stage of app usage in which a user of the app device has finished using the app, and
wherein for the exit stage, the subset includes a notification ad type and an app icon ad type.

10. The method of claim 1 wherein each subset is different to each other subset.
